(19) United States
(12) Patent Application Publication
(10) Pub. No.: US 2011/0234876 A1
(43) Pub. Date: Sep. 29, 2011

(54) IMAGE SENSOR WITH DOUBLE CHARGE TRANSFER FOR LARGE DYNAMIC RANGE AND METHOD OF READING

(75) Inventor: Jacques Leconte, Berland (FR)

(73) Assignee: E2V SEMICONDUCTORS, Saint Egreve (FR)

(21) Appl. No.: 13/133,052

(22) PCT Filed: Dec. 10, 2009
(86) PCT No.: PCT/EP2009/066860

§ 371 Date: Jun. 6, 2011

(30) Foreign Application Priority Data
Dec. 12, 2008 (FR) 0806999

(51) Int. Cl. H04N 5/335

(52) U.S. Cl. 348/308; 348/E05.091

(57) ABSTRACT

The invention relates to image sensors with active pixels.

To obtain a wide dynamic operating range, the pixels are read by performing a double charge integration, during periods of different values (Ti1, Ti2). The result of the first integration (period Ti1) is sampled (command SHS1) in a sampling capacitor, and the result of the second integration (period Ti2) is conditionally sampled (command SHS2) in the same capacitor. This second sampling depends on the observation of the potential of the column conductor after the integration of charges corresponding to the longer period; this potential is compared to a threshold. If the comparison indicates a risk of saturation, the information collected during the shorter period is collected and retained in the sampling capacitor in order for it to be multiplied by a coefficient representing the ratio between the longer period and the shorter period. If the comparison indicates that there is no risk of saturation, the information collected during the longer period is collected and retained in the sampling capacitor. The shorter period is, in principle, the first period.

### CROSS-REFERENCE TO RELATED APPLICATIONS

The present Application is based on International Application No. PCT/EP2009/066860, filed on Dec. 10, 2009, which in turn corresponds to French Application No. 0806999, filed on Dec. 12, 2008, and priority is hereby claimed under 35 USC §119 based on these applications. Each of these applications are hereby incorporated by reference in their entirety into the present application.

### FIELD OF THE INVENTION

The invention relates to electronic image sensors and more particularly, those which work on the basis of active pixels in MOS technology. The invention relates notably to a method for controlling the various transistors that make up the pixels.

### BACKGROUND OF THE INVENTION

The active pixels usually comprise a photodiode and three, four or five MOS transistors making it possible to control the reading of the charges generated by the light in the photodiode. The pixels with three transistors work by directly transferring to a column conductor the potential of the photodiode, a potential which varies according to the lighting and the light integration time. The pixels with four transistors work by first transferring from the photodiode to a capacitive storage node the charges generated by the light, then by referring the potential of the storage node to a column conductor; one of the transistors is used to reset the potential of the storage node before the charge transfer from the photodiode to the storage node. The pixels with five transistors also include a transistor for resetting the potential of the photodiode.

Interest is more particularly focused here on the pixels with four or five transistors. The structure of a pixel with five transistors is reviewed in FIG. 1. Such a pixel comprises a photodiode PD, a capacitive storage node ND (represented by a simple dot in FIG. 1, and in practice implemented by a small N-type diffusion into a P-type substrate), a charge transfer transistor T1 between the cathode of the photodiode and the storage node, a transistor T2 for resetting the potential of the storage node, a transistor T3 for resetting the potential of the cathode of the photodiode, a follower transistor T4, a row selection transistor T5. For a pixel with four transistors, the transistor T3 would be eliminated.

The photodiode generally consists of an N-type diffusion into a P substrate, but this diffusion is preferably covered by a surface region P+ linked to the ground, which makes it possible to better set its potential when it is reset. The transfer transistor T1 is controlled by a transfer signal TG. The transistor T2 for resetting the storage node has its drain linked to a reset potential VRS (which is usually the power supply potential Vdd) and it is controlled by a reset control signal RST. The transistor T3 for resetting the photodiode is linked between the cathode of the photodiode and a power supply potential Vdd. It is controlled by a reset signal Rph. The follower transistor T4 has its drain linked to a reference potential which may be the power supply Vdd, its source linked to the row selection transistor T5, and its gate linked to the storage node ND. Finally, the row selection transistor T5 has its gate linked to a row selection conductor LS which links all the row selection transistors of one and the same row of pixels; this row is controlled by a row selection signal SEL specific to this row; the drain of T5 is linked to the source of the follower transistor and its source is linked to a column conductor CC common to all the pixels of one and the same column of pixels. This column conductor is linked to a read circuit which is not represented, at the foot of the column.

The way that a matrix comprising such pixels with five transistors usually works is as follows. It is described with reference to the timing diagram of FIG. 2.

A time pulse Rph is applied to the gate of the transistor T3. Its duration or its position depends on the desired integration time for an image. In practice, as long as this pulse is active, it prevents any integration of charges in the photodiode. The integration time Ti starts when this pulse ends (time t₀).

At the end of the period Ti, a transfer pulse TG is applied to the gate of the transfer transistors T1 of the row. This pulse enables the discharging into the storage node ND of all the charges accumulated in the photodiode. The end of this pulse marks the end of the integration time Ti for a row or for the entire matrix.

The row selection transistor T5 is then made to conduct by a row selection pulse SEL (row by row). Only the pulse SEL for the first row of the matrix is represented. The pulses for the other rows follow, without overlapping. Throughout the pulse SEL, the potential present on the storage node ND of the transistors of the row is referred by the follower transistor T4 to the column conductor CC and is read by a respective read circuit associated with each column.

During the pulse SEL, and for each row, a command pulse SHS is applied in the read circuit (not represented) at the foot of the column of pixels, to take a first sample of the potential present on the column conductor. This potential depends on the quantity of charges resulting from the lighting of the pixel during the integration period Tᵢ.

Then, still during the same pulse SEL, a pulse RST_{L} is applied to the gates of the transistors T2 of all the pixels of the selected row. The potential of the storage node is reset to a value dictated by the value VRS applied to the drain of the transistors T2.

Finally, still during the same pulse SEL, a pulse SHR is applied to the read circuit to take a second sample of the potential of the column conductor.

An analog-digital convertor converts the difference between the two samples. The convertor is specific to each column or else unique for all the columns.

It is desired that the sensor should store images that have the widest possible dynamic range, that is to say, pixels that are sensitive in the presence of a low lighting but capable of receiving very luminous images without saturation are wanted. A number of solutions have been sought to obtain a wide dynamic range.

One solution consists in using a successive capture of a number of images with different integration times. If the signal supplied by a pixel that has undergone a long integration time is saturated, it is replaced by a signal from the same pixel, having undergone a short integration time. This presupposes taking several successive images and the overall acquisition time is long. Furthermore, the images have to be processed pixel by pixel in order to choose the most suitable signal for each before going on to a next image.

Another solution consists in having a mixed matrix with small pixels and large pixels. The small pixels, less sensitive, are used if there is a lot of light. A complex suitable processing is required and the overall resolution of the matrix is reduced.

Yet another solution consists in measuring the time that it takes a pixel to arrive at saturation to deduce therefrom information concerning the level of light in the presence of saturating lighting. This presupposes more complex pixels.

Solutions with pixels with logarithmic or linear-logarithmic function or with response curve slope variation have also been proposed for pixels with three transistors. These rely on a variation of the potential of the gate of the transistor for resetting the photodiode. These solutions are sensitive to technological dispersions: dispersion of threshold voltages of the transistors of the various pixels and dispersion of the no-load potential of the photodiode after reset.

The PCT publication WO 99/34592 proposes a device whose read circuit comprises a first capacitor for storing a potential level for resetting the storage node of the pixel, a second capacitor for storing a potential level taken by the storage node after a first integration period, a third capacitor for storing a potential level taken by the storage node after a second integration period following the first but much shorter than the first, and a threshold circuit for comparing the potential level in the first capacitor with a threshold and using the potential stored in the second capacitor rather than in the first in the case where, as a result of excessively strong lighting, the threshold would be exceeded.

This device requires three sampling capacitors. Now, the sampling capacitors occupy a very large surface area in the read circuit (around 15% of the surface area for each capacitor). Also, the matrix image sensors are highly sensitive to an effect which is the fixed read noise in column mode. This noise results from the offset dispersions of the column amplifiers and is reflected in parallel vertical lines which are very visible to the eye when the images are displayed. There are methods for reducing it, but these methods do not apply if there are three capacitors. It should also be noted that if this noise is not eliminated, it is ultimately multiplied by the ratio of the integration periods in the case where the second capacitor is used rather than the first.

### SUMMARY OF THE INVENTION

The aim of the invention is to propose a method for controlling the sensor, which makes it possible to obtain a wide dynamic range, by using only two capacitors which makes it possible in particular to reduce the fixed column noise, and by retaining a linearity of the signal relative to the received luminosity, for low lightings and for strong lightings. This linearity facilitates in particular the colorimetric corrections in the color image sensors, whereas a non-linear response makes the colorimetric corrections more difficult. A non-linear response also makes the automatic gain or exposure corrections more difficult.

According to the invention, there is proposed a method for reading charges deriving from pixels of an image capture matrix, in which the pixels of one and the same row are addressed simultaneously for each to establish, on a respective column conductor linked to a read circuit, a potential level representing the charges generated by the lighting of this pixel, and in which a pixel comprises at least one photodiode, a charge storage node, and a row selection transistor for linking the storage node to the column conductor or isolating it from this conductor. The integration of charges in the photodiode and the reading of the charges are done according to the following sequence of operations: integration of charges in the photodiode during a first integration period Ti1, first transfer of the duly integrated charges from the photodiode to the storage node at the end of the first integration period, integration of charges in the photodiode during a second period Ti2 different from the first, establishment of a connection between the storage node and the column conductor, first sampling, in a capacitor of the read circuit, of a first potential level present at this moment on the column conductor and resulting from the first charge transfer, second charge transfer from the photodiode into the storage node, and, subsequently, an analog-digital conversion of the sampled potential level in the capacitor. The method is characterized in that a second conditional sampling is performed, in the same capacitor, of a second potential level present on the column conductor and resulting from the second charge transfer, the second sampling being conditioned by the result of a comparison between the first or the second potential level present on the column conductor and a predetermined threshold level; the result of the comparison is transmitted to determine a multiplying factor to be applied to the result of the analog-digital conversion.

In other words, two successive potential level reads are done after two integrations of consecutive different durations, and the first read is overwritten by the second according to the signal level generated on the column conductor by the longer of the two periods. Depending on whether the level (in terms of lighting level, that is to say quantity of charges accumulated in the storage node) exceeds or does not exceed the threshold, a choice is made to retain the level sampled in the capacitor for the first period or to replace it by the one sampled after the second period; the retained level or the new sampled level is then converted into a digital value. Furthermore, the result of the comparison is retained in memory. If the lighting threshold is exceeded, the result of the digital conversion is subsequently multiplied by a value which is in the ratio of the longer to shorter period. If the threshold is not exceeded, the result of the conversion is retained. In practice, the multiplication is done outside the image sensor, the sensor sending only an instruction bit concerning the need for a multiplication.

The invention is applicable in principle in the case of the so-called “rolling shutter” sensor operating modes, that is to say, the modes in which the resetting of the photodiodes is done row by row and not simultaneously for all the rows. All the rows incorporate the charges during one and the same period but not at the same moments.

In practice, the pixel comprises a transistor for resetting the level of the storage node, making it possible to reset the potential of the storage node to a predetermined level; the level resetting is done by briefly making this transistor conduct after the first sampling; and an intermediate sampling, in a second sampling capacitor of the sampling circuit, is performed between this level resetting and the second sampling; the analog-digital conversion relates to the potential difference between the sampled level in the first capacitor and the sampled potential level in the second capacitor, and not to the absolute value of the potential of the first capacitor, so that voltage drops such as the gate-source voltage drop of the follower transistor, and other low-frequency noises, are eliminated.

The first integration period Ti1 is preferably of a duration much shorter than the second integration period Ti2. In this case, the comparison with the threshold is performed with the second potential level present on the column conductor, resulting from the second charge transfer from the photodiode to the storage node. For this, the comparison instant is located between the start of a pixel row selection pulse and a reset of the potential of the storage node; the result of the comparison is then retained.

Provision could also be made (less advantageously) for the second storage period to be much shorter than the first. In this case, the comparison with the threshold would be performed with the potential present on the column conductor and stored in the first sampling capacitor after the first charge transfer.

In addition to the reading method which has just been summarized, the invention proposes an image sensor in MOS technology, comprising a matrix of pixels organized in rows and in columns, the pixels of one and the same column being linked to a column conductor which is in turn linked to a read circuit, each pixel comprising a photodiode linked by a transfer transistor to a storage node, and a row selection transistor for linking the storage node to the column conductor or isolating it from this conductor. This sensor comprises means for performing, during one and the same cycle of integration and of reading of the charges of a pixel, two charge transfers, the first after a first integration period, the second after a second integration period different from the first, and a means for sampling in a sampling capacitor the potential level taken by the column conductor after the first charge transfer. The sensor is characterized in that it comprises a comparator for comparing the potential taken by the column conductor after the longer of the two periods with a threshold, a means for replacing or not replacing, depending on the result of the comparison, the content of the sampling capacitor with the potential level taken by the column conductor after the second charge transfer, and a means for supplying a digital output signal which is, depending on the result of the comparison,
either a digital value representing the potential level taken by the column conductor after the longer of the two periods,
or a digital value representing the potential level taken by the column conductor after the shorter of the two periods,
and an information bit concerning the result of the comparison.

This bit represents an information item concerning the choice of the value transmitted. It also represents a binary instruction concerning the need (in the second case) to multiply the value supplied as output by the ratio between the longer and the shorter of the two periods. The first period is very advantageously the shorter.

### BRIEF DESCRIPTION OF DRAWINGS

Other features and advantages of the invention will become apparent from reading the following detailed description which is given with reference to the appended drawings in which:

FIG. 1, already described, represents the conventional construction of a CMOS active pixel with five transistors;

FIG. 2, already described, represents the conventional operating timing diagram of the pixel of FIG. 1;

FIG. 3 represents the operating timing diagram in the method according to the invention;

FIG. 4 represents a read circuit suitable for implementing the reading method according to the invention;

FIG. 5 represents another possible timing diagram in a variant embodiment of the reading method.

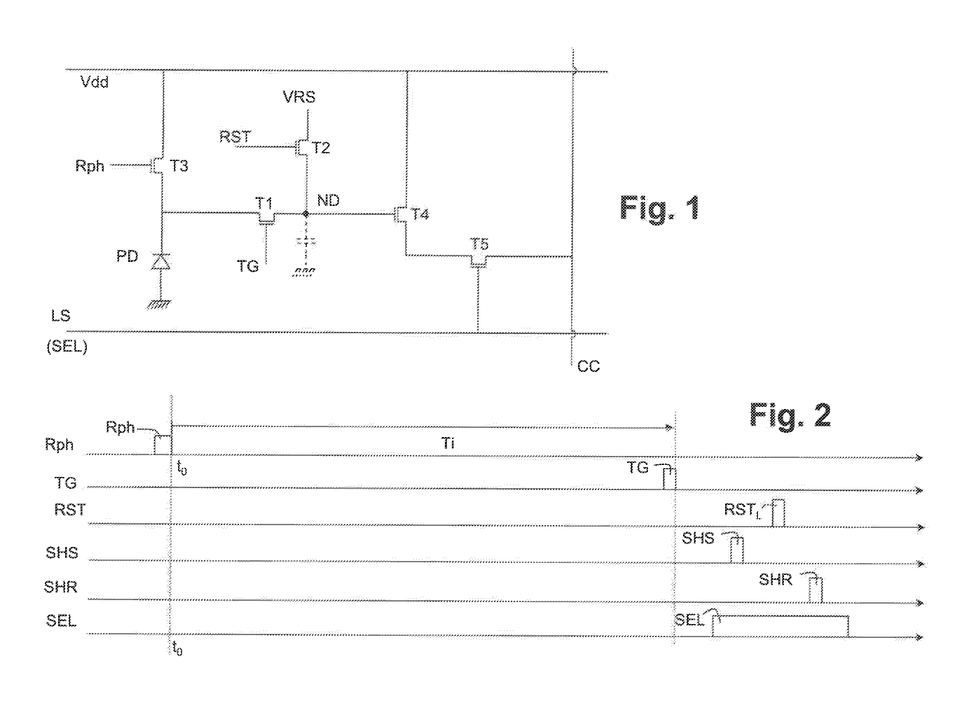

### DESCRIPTION OF PREFERRED EMBODIMENTS

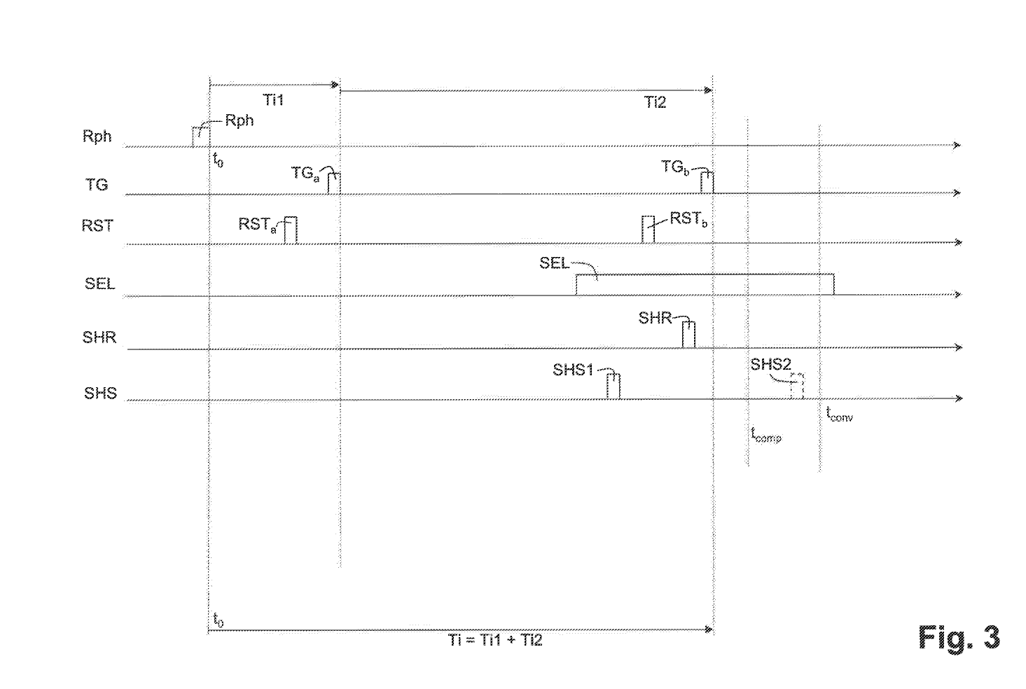

The method according to the invention can be applied to a pixel with five transistors similar to that of FIG. 1. The control timing diagram according to the invention is represented in FIG. 3 in a case where a charge integration cycle comprises two successive periods Ti1 then Ti2 in which Ti1 is much shorter than Ti2. As will be seen below, the reverse is also possible.

A reset time pulse Rph is applied to the gate of the transistor T3 for an entire row of pixels. This pulse acts to empty to the power supply potential Vdd the charges stored in the photodiode PD. As long as this pulse lasts, the integration of charges in the photodiode is prevented. It is then authorized as soon as this pulse ends, at an instant t₀ and until the end of the reading of the charges corresponding to the current integration cycle. A new integration cycle begins at the time of a new pulse Rph.

The pulse Rph is supplied independently for each row, so that the time tₒ begins at successive instants for the successive rows. Only the timing diagram corresponding to one row is represented.

A first integration of charges in the photodiode PD occurs from the time t₀ and for a period Ti1.

At an intermediate instant during this period, a brief pulse RSTₐ is produced on the gate of the transistors T2 of all the pixels of the row which makes these transistors conduct. The potential of the storage node ND is reset, for all the transistors of the row, to a fixed value.

Then, a charge transfer pulse TGₐ is applied to the command gate of the transfer transistors T1 of the row. The charges generated by the light in the photodiode are discharged into the storage node. They modify the potential of this node. The end of the first charge integration period Ti1 is defined by the end of the first transfer pulse TGₐ.

A second integration period Ti2 then begins. The photodiode has been emptied of its charges during the pulse TGₐ and now integrates other charges.

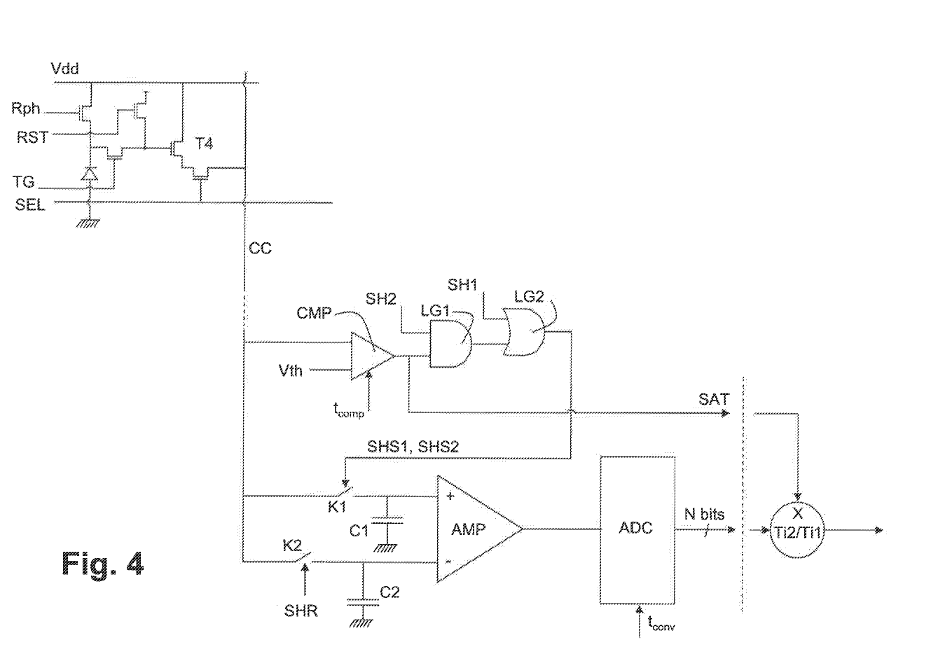

Before the end of the period Ti2, a pulse SEL for selecting the row of pixels to trigger the procedure for reading the pixels of this row is established on the row LS. This pulse makes the row selection transistor T5 conduct. This activates the follower transistor T4 and refers the potential from the storage node ND to the column conductor CC (to within a transistor gate-source voltage). The column conductor then takes a first potential level. The pulse SEL remains active throughout the reading of the pixels of the row concerned, then it is interrupted and it is only after this interruption that a similar pulse can be applied to another row. During the pulse SEL, the following operations are performed:
a command pulse SHS1 is applied to the read circuit (represented in FIG. 4) at the foot of the column of pixels, to collect, in a first capacitor C1 of the read circuit, a first sample of the potential present on the column conductor; this potential results from the first charge transfer and therefore depends on lighting of the pixel during the first integration period Ti1;
in the far preferable case in which a read by difference between the potential level after discharging of charges and the potential level after resetting of the storage node is desired, a second reset pulse RST_{b} is established; this pulse is applied to the gates of the transistors T2 of the row of pixels; the potential of the storage node is reset to a fixed value; a command pulse SHR is then applied to the read circuit, to take an intermediate sample of the reset column potential, in a second sampling capacitor C2 of the read circuit;
there is then applied, for all the pixels of the row, a second transfer pulse TG_{b} to the gate of the transfer transistor T1; the charges integrated during the period Ti2 in the photodiode are discharged into the storage node ND; the period Ti2 ends at the end of the pulse TG_{b}; the potential of the column conductor follows (to within a gate-source voltage) the potential level of the storage node following this second charge transfer.

According to the invention, a choice is made to store or not to store in the first capacitor of the read circuit the potential taken at this moment by the column conductor and the choice is made, in the exemplary timing diagram of FIG. 3, according to the second potential level taken by the column conductor following the second discharging of charges representing the lighting during the period Ti2; if this second level indicates that a charge quantity threshold has been exceeded in the storage node, which amounts to indicating a risk of saturation of the measured signal, the storing is not done; if, on the other hand, this charge quantity threshold is not exceeded, the storing is done.

For this, a second command pulse SHS2 is applied conditionally to the read circuit to take a second sample of the potential of the column conductor in the first sampling capacitor of the read circuit. This pulse SHS2 is applied only subject to a condition defined by the comparison between the second potential level of the column conductor after the second discharge and a threshold value. The pulse SHS2 has been represented in dotted lines in FIG. 3 because it may be present or absent depending on the result of the comparison.

The comparison is performed during the read, that is to say, during the pulse SEL. The instant of the comparison t_{comp} is located after the end of the second transfer pulse TG_{b}. The comparison with a threshold is therefore done on the basis of the potential present on the column conductor and resulting from the second discharging of charges. This potential represents the lighting during the period Ti2.

The result of the comparison is kept in memory until the end of the read (end of the SEL pulse). This result is transmitted as binary information at the output of the sensor, this information representing information concerning the exceeding of a pixel saturation threshold.

Thus, in the case of FIG. 3 in which Ti1 is much shorter than Ti2, the read operates according to two possibilities:
if the potential of the column conductor resulting from the second discharging of charges shows that the quantity of charges integrated during the period Ti2 exceeds a threshold, then it is considered that there is saturation of the storage node; no pulse SHS2 is emitted; the charges stored in the first sampling capacitor are retained; they are converted into digital form, they are transmitted at the output of the sensor and a saturation information bit is also transmitted which will be used (in principle outside the sensor) to multiply the digital value supplied by the ratio between the period Ti2 and the period Ti1; the value resulting from the multiplication is a value proportional to the lighting during the period Ti1;
if, however, the charge quantity threshold is not exceeded, there is no risk of saturation; the pulse SHS2 is emitted; the content of the first sampling capacitor is overwritten and takes a new sample of the potential of the column, resulting from the second discharging of charges; the sample therefore represents the lighting during the period Ti2; it is this sample which is converted into digital form; the output signal from the read circuit is this value, proportional to the lighting; the saturation information bit indicates that there is no saturation and therefore no need to multiply the digital value supplied by the sensor by a coefficient.

Obviously, in the case where an intermediate sampling is done, after the pulse SHR, in a second sampling capacitor C2, it is the difference between the potentials in the first and the second sampling capacitors which is applied to an analog-digital convertor to supply a signal value representing the lighting, both with low lighting and with strong lighting. The offset voltages introduced notably by the follower transistor T4 are thus eliminated by difference, and the noise that can affect the level of the reset potential of the storage node (so-called “reset noise”) is also largely eliminated for the lower lighting levels. In practice, the difference between a level read during the pulse SHS2 and a reset level read immediately previously (during the pulse SHR) is then calculated. This is a true correlated double sampling, because the reset level stored during the pulse SHR results from a reset (pulse RST_{b}) prior to the discharging of the charges (pulse TG_{b}) that is to be read. On the other hand, when the saturation threshold is exceeded, the sampling is not a correlated double sampling because the reset level stored in the capacitor results from the pulse RST_{b} which comes after the discharging of the charges (resulting from the pulse TGₐ).

The analog-digital conversion is performed from an instant t_{conv} situated after the pulse SHS2. It can be done after the end of the row selection pulse SEL, provided that it is ended before the pulse SHS1 of the next row.

FIG. 4 represents a read circuit making it possible to implement the reading method according to the invention. A pixel at the intersection of a row and a column has been represented. The read circuit is placed at the foot of the column. In this example, it comprises two sampling capacitors C1 and C2; the capacitor C1 is linked to the column conductor CC via a switch K1 actuated by the signals SHS1 (on each new read of a row) and SHS2 (on each row read but each time subject to the results supplied by a comparator CMP). The capacitor C2 is linked to the column conductor CC via a switch K2 actuated by the signals SHR (on each new read of a row). An amplifier AMP collects the difference between the levels stored in the two capacitors and transmits it to an analog-digital convertor ADC. The latter is activated at the time t_{conv} as explained above.

A small logic circuit associated with the comparator CMP produces the pulse SHS2 according to the result of the comparison between a potential level present on the column conductor (at the instant t_{comp} defined above) and a threshold level Vth. The result of the comparison is retained in memory between the instant t_{comp} and the end of the reading of the row.

In the example of FIG. 4, the logic circuit produces both the pulse SHS1 and the pulse SHS2. To this end, it receives a time pulse SH1 and a time pulse SH2 which are produced by a sequencer at two different instants corresponding to the instants chosen for the pulses SHS1 and SHS2. The pulse SH1 is applied to an input of an OR gate (LG2), the output of which controls the switch K1. It passes through this gate when it is emitted and produces the signal SHS1. The pulse SH2 is applied to an input of an AND gate LG1. It passes through this gate, to supply a signal SHS2, only for one of the two output states of the comparator CMP. A second input of the AND gate LG1 receives, for this purpose, the output of the comparator CMP. The output of the AND gate LG1 is applied to another input of the OR gate LG2.

The comparator CMP stores the result (signal SAT) of the comparison. The signal SAT has, for example, a logic 1 state if the quantity of charges discharged during the second integration period (the longer) exceeds a threshold which indicates a risk of saturation.

The signal SAT is supplied at the output of the sensor and is used to establish the final digital value of the signal representing the lighting seen by the pixel. The analog-digital convertor ADC supplies a digital value for example on N bits and this value is the result of the first or the second integration depending on the state of the output SAT. If the signal SAT is at a level (for example 1) which indicates that there is a saturation, the value deriving from the analog-digital conversion results from the integration over the shorter of the two periods and will have to be multiplied, in principle outside the sensor, by a coefficient representing the ratio Ti2/Ti1. Otherwise, the output value on N bits is used as is.

It will be noted that the direction of operation of the comparator depends on the sign of the potential variations of the column conductor. Conventionally, the potential of the column conductor, assumed positive, becomes lower as the quantity of charges discharged into the storage node becomes greater. Consequently, the exceeding of a charge quantity threshold is reflected by the column conductive potential falling below a threshold.

As an example, the number N may be 10, and the ratio of the periods may be 64 or 128.

Because there is a need only for one capacitor C1 for the signal level to be placed in memory, and a capacitor C2 for the reset level to be placed in memory, the fixed column noise, which could be due to a dispersion of the offset values of the amplifiers AMP from column to column, can easily be eliminated. This elimination can be done by an auto-zero phase in which the two inputs of the amplifier (which are directly linked to the capacitors) are short-circuited. The offset which results from this short circuit is retained in memory and restored on the first actual read after the auto-zero phase. A simple elimination is not possible with the circuit with three capacitors of the aforementioned document WO 99/34592.

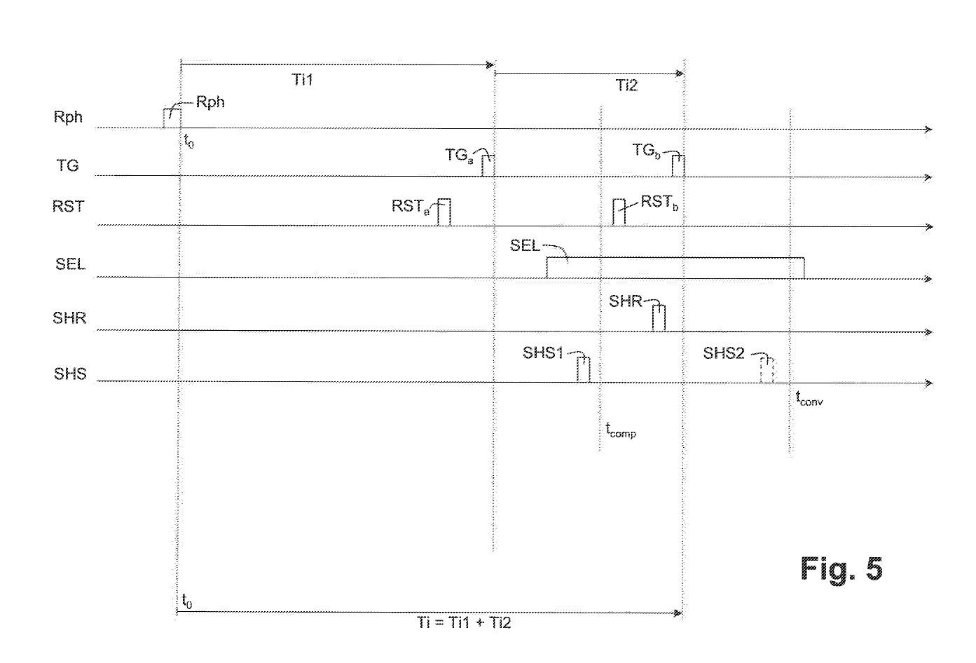

FIG. 5 represents a variant operating timing diagram in which it is chosen to have a period Ti2 much shorter than the period Ti1. This variant is, however, much less interesting in that it allows for a measurement by true correlated double sampling for the measurements of strong luminances (above the saturation threshold) and therefore for the measurements resulting from the short integration, but not for the measurements of low luminances. Whereas the embodiment of FIGS. 3 and 4 allows for a true correlated double sampling for the measurements of low luminances, below the saturation threshold, but not for the measurements of strong luminances. It is much more advantageous to have a true correlated double sampling for the low luminances. The difference relative to the timing diagram of FIG. 3 is the fact that the instant of the comparison t_{comp} is situated before the second transfer pulse TG_{b}. The comparison with a threshold is therefore done on the basis of the potential present on the column conductor and resulting from the first discharging of charges. This potential represents the lighting during the period Ti1 whereas in the case of FIG. 3, it represented the lighting during the period Ti2.

To make the comparison, it is possible to compare with a threshold either the potential of the column conductor when it is at the first level, or, which amounts to the same thing, the potential that has been stored in the first sampling capacitor C1 since it is precisely equal to this first level. If the comparison is done by using the column conductor, the comparison must be done at an instant t_{comp} necessarily situated before the second transfer pulse TG_{b} and even before the storage node reset pulse RST_{b}. If, on the other hand, the comparison is done by using the potential of the first sampling capacitor, the comparison can be done at any instant t_{comp}, but one situated after the pulse SHS1 (and, of course, before the instant planned for the pulse SHS2). The result of the comparison is kept in memory until the end of the read and of the analog-digital conversion since it must be transmitted as binary saturation information SAT at the output of the sensor.

A circuit similar to that of FIG. 4 can also be used but with the following two differences: on the one hand, the direction of the comparison must be reversed, in that the signal SHS2 must be emitted when there is a risk of saturation (exceeding of a quantity of charges discharged into the storage node during the period Ti1); the potential of the sampling capacitor (resulting from the lighting during the period Ti1) is then replaced by the second potential level of the column conductor, resulting from the second charge transfer. Also, on the other hand, in case of saturation, the saturation bit signifies that the output of the sensor must be multiplied by Ti1/Ti2 and not by Ti2/Ti1, that is to say that it is always multiplied by the ratio between the longer period and the shorter period.

1. A method for reading charges deriving from pixels of an image capture matrix, in which the pixels of one and the same row are addressed simultaneously for each to establish, on a respective column conductor linked to a read circuit, a potential representing the charges generated by the lighting of this pixel, and in which a pixel comprises at least one photodiode, a charge storage node, and a row selection transistor for linking the storage node to the column conductor or isolating it from this conductor, the integration of charges in the photodiode and the reading of the charges being done according to the following sequence of operations:
integration of charges in the photodiode during a first integration period,
first transfer of the thus integrated charges from the photodiode to the storage node at the end of the first integration period,
integration of charges in the photodiode during a second integration period different from the first,
establishment of a connection between the storage node and the column conductor,
first sampling, in a capacitor of the read circuit, of a first potential present at this moment on the column conductor and resulting from the first charge transfer,
second charge transfer from the photodiode into the storage node, and, subsequently, an analog-digital conversion of the sampled potential in the capacitor,
wherein a second conditional sampling is performed, in the same capacitor, of a second potential level present on the column conductor and resulting from the second charge transfer, an actuation of the second sampling being conditioned by the level of the first or the second potential present on the column conductor, an information on the actuation of the second sampling being transmitted to determine a multiplying factor to be applied to the result of the analog-digital conversion.

2. The method as claimed in claim 1, wherein a signal representing the lighting of the pixel is established by multiplying the output of the analog-digital conversion by the ratio between the longer and the shorter integration period in the case where the level of the first or second potential on the column indicator indicates that the threshold of charge quantities discharged into the storage node during the longer of the first and second integration periods is exceeded.

3. The method as claimed in claim 1, wherein the pixel comprises a transistor for resetting the level of the storage node, making it possible to reset the potential of the storage node to a predetermined level, in that the level resetting is done by briefly making this transistor conduct after the first sampling, and in that an intermediate sampling, in a second sampling capacitor of the sampling circuit, is performed between this level resetting and the second sampling.

4. The method as claimed in claim 1, wherein the first integration period is shorter than the second integration period, and actuation of the conditional sampling is conditioned by the level of the second potential present on the column conductor, resulting from the second charge transfer from the photodiode to the storage node.

5. An image sensor in MOS technology, comprising a matrix of pixels organized in rows and in columns, the pixels of one and the same column being linked to a column conductor which is in turn linked to a read circuit, each pixel comprising a photodiode linked by a transfer transistor to a storage node, and a row selection transistor for linking the storage node to the column conductor or isolating it from this conductor, the sensor comprising means for performing, during one and the same cycle of integration and of reading of the charges of a pixel, two charge transfers, the first after a first integration period, the second after a second integration period different from the first, and a means for sampling in a sampling capacitor the potential level taken by the column conductor after the first charge transfer, wherein it further comprises a means for evaluating the potential taken by the column conductor after the longer of the two periods, a means for replacing or not replacing, depending on the result of the evaluation, the content of the sampling capacitor with the level of the second potential taken by the column conductor after the second charge transfer, and a means for supplying a digital output signal which is,
either a digital value representing the potential taken by the column conductor after the longer of the two periods,
or a digital value representing the potential taken by the column conductor after the shorter of the two periods,
and an information bit representing the actuation or absence of actuation of the conditional sampling.

6. The image sensor as claimed in claim 5, wherein the first period is shorter than the second.

7. The method as claimed in claim 2, wherein the pixel comprises a transistor for resetting the level of the storage node, making it possible to reset the potential of the storage node to a predetermined level, in that the level resetting is done by briefly making this transistor conduct after the first sampling, and in that an intermediate sampling, in a second sampling capacitor of the sampling circuit, is performed between this level resetting and the second sampling.

8. The method as claimed in claim 2, wherein the first integration period is shorter than the second integration period, and actuation of the conditional sampling is conditioned by the level of the second potential present on the column conductor, resulting from the second charge transfer from the photodiode to the storage node.

9. The method as claimed in claim 3, wherein the first integration period is shorter than the second integration period, and actuation of the conditional sampling is conditioned by the level of the second potential present on the column conductor, resulting from the second charge transfer from the photodiode to the storage node.
